(19) United States
(12) Patent Application Publication
(10) Pub. No.: US 2026/0118121 A1
(43) Pub. Date: Apr. 30, 2026

(54) LIGHT TRANSMITTER, SURVEY SYSTEM, AND METHOD FOR AUTOMATICALLY RESUMING TRACKING

(71) Applicant: TOPCON CORPORATION, Tokyo (JP)

(72) Inventors: Nobuyuki NISHITA, Tokyo (JP); Minoru CHIBA, Tokyo (JP)

(73) Assignee: TOPCON CORPORATION, Tokyo (JP)

(21) Appl. No.: 19/116,963

(22) PCT Filed: Sep. 28, 2023
(86) PCT No.: PCT/JP2023/035364

§ 371 Date: Mar. 28, 2025

(30) Foreign Application Priority Data
Sep. 30, 2022 (JP) 2022-159148

(51) Int. Cl. G01C 15/00; G01C 15/06; G01S 7/481; G01S 17/42; G01S 17/66; G01S 17/89

(52) U.S. Cl. CPC G01C 15/002; G01C 15/06; G01S 7/4817; G01S 17/42; G01S 17/66; G01S 17/89

(57) ABSTRACT

Provided is a light transmitter that automatically directs a light transmission port to a surveying instrument. A light transmitter includes a transmitter main body configured to transmit tracking guide light, a drive unit, an inertial measurement unit, an angle detector, a transmitter communication unit, and a transmitter control unit, in which the light transmitter control unit causes the light transmitter communication unit to receive a horizontal direction angle of a surveying instrument, calculates a difference between a light transmission direction of the tracking guide light and an azimuth angle to the surveying instrument as an angle from the measured value of the inertial measurement unit and the measured value of the angle detector, and rotatably drives the drive unit such that the light transmission direction of the tracking guide light is directed to the surveying instrument to transmit the tracking guide light.

### TECHNICAL FIELD

The disclosure relates to a light transmitter, a survey system, and a method for automatically resuming tracking.

### BACKGROUND ART

Patent Literature 1 has disclosed some surveying instruments include an auto-tracking device. When the tracking deviates, an operator gripping a pole attached a prism holds an optical transmitter transmits a transmission signal (tracking guide light) to a surveying instrument with light from the optical transmitter. The surveying instrument receives the transmission signal, detects an arrival direction of the transmission signal, and directs a telescope in the arrival direction of the transmission signal. This allows the surveying instrument to quickly lock the prism and track it again.

### CITATION LIST

### Patent Literature

Patent Literature 1: JP No. 3075384

### SUMMARY

### Technical Problem

However, in the method of patent literature 1, when tracking deviates, the operator has to stop the surveying work, direct a light transmission port of a remote controller to the surveying instrument, and press a switch to transmit a transmission signal, which is troublesome for the operator.

The disclosure has been made in view of such a problem, and an object thereof is to provide a light transmitter that automatically directs a light transmission port to a surveying instrument, a survey system, and a method for automatically resuming tracking.

### Solution to Problem

To achieve the above object, according to an aspect of the present disclosure, there is provided a light transmitter including a transmitter main body configured to transmit tracking guide light; a drive unit configured to drive the transmitter main body to be rotated horizontally; an inertial measurement unit configured to measure accelerations in three axial directions of the transmitter main body; an angle detector configured to detect a rotation angle of the transmitter main body; a transmitter communication unit configured to transmit and receive information; and a transmitter control unit configured to control arithmetic processing for measured values of the inertial measurement unit and the angle detector, the transmitter communication unit, transmission of the tracking guide light of the transmitter main body, and rotation of the drive unit, in which the light transmitter control unit causes the light transmitter communication unit to receive a horizontal direction angle from a surveying instrument to the light transmitter main body and a first movement direction of the light transmitter main body, calculates a difference between a light transmission direction of the tracking guide light and an azimuth angle to the surveying instrument as an angle from the measured value of the inertial measurement unit and the measured value of the angle detector, and rotatably drives the drive unit such that the light transmission direction of the tracking guide light is directed to the surveying instrument to transmit the tracking guide light.

Furthermore, in the aspect, the light transmitter control unit calculates a second movement direction of the light transmitter from the measured value of the inertial measurement unit, matches the first movement direction and the second movement direction, and calculates a difference with a horizontal azimuth angle to the surveying instrument as an angle.

Furthermore, in the aspect, the tracking guide light is configured to emit light at different frequencies in a left region and a right region in a horizontal direction around the light transmission direction, and emit light at a frequency different from both the frequency of the left region and the frequency of the right region in a region including the light transmission direction.

According to another aspect, there is provided a survey system including a light transmitter including a light transmitter main body configured to transmit tracking guide light, a drive unit configured to drive the light transmitter main body to be rotated horizontally, an inertial measurement unit configured to measure accelerations in three axial directions of the light transmitter main body, an angle detector configured to detect a rotation angle of the light transmitter main body, a light transmitter communication unit configured to transmit and receive information, and a light transmitter control unit configured to control arithmetic processing for measured values of the inertial measurement unit and the angle detector, the light transmitter communication unit, light transmission of the tracking guide light of the light transmitter main body, and rotation of the drive unit; a prism attached to the light transmitter; and a surveying instrument including a light receiving unit configured to receive the tracking guide light, and a surveying instrument communication unit configured to communicate with the light transmitter communication unit, the surveying instrument having a tracking function and a distance measurement and angle measurement function of measuring a distance to and an angle of the prism, in which the light transmitter control unit causes the light transmitter communication unit to receive a horizontal direction angle from the surveying instrument to the light transmitter main body and a first movement direction of the light transmitter main body, calculates a difference between a light transmission direction of the tracking guide light and an azimuth angle to the surveying instrument as an angle from the measured value of the inertial measurement unit and the measured value of the angle detector, and rotatably drives the drive unit such that the light transmission direction of the tracking guide light is directed to the surveying instrument to transmit the tracking guide light.

According still another aspect, there is provided a method for automatically resuming tracking when tracking deviates in a survey system that includes a light transmitter including a light transmitter main body configured to transmit tracking guide light, a drive unit configured to drive the light transmitter main body to be rotated horizontally, an inertial measurement unit configured to measure accelerations in three axial directions of the light transmitter main body, an angle detector configured to detect a rotation angle of the light transmitter main body, a light transmitter communication unit configured to transmit and receive information, and a light transmitter control unit configured to control arithmetic processing for measured values of the inertial measurement unit and the angle detector, the light transmitter communication unit, light transmission of the tracking guide light of the light transmitter main body, and rotation of the drive unit, a prism attached to the light transmitter, and a surveying instrument including a light receiving unit configured to receive the tracking guide light, and a surveying instrument communication unit configured to communicate with the light transmitter communication unit, the surveying instrument having a tracking function and a distance measurement and angle measurement function of measuring a distance to and an angle of the prism, the method including
(a) a step of receiving, by the light transmitter communication unit, a horizontal direction angle from the surveying instrument to the light transmitter main body and a first movement direction of the light transmitter main body from the surveying instrument;
(b) a step of calculating, by the light transmitter control unit, a difference between a light transmission direction of the tracking guide light and an azimuth angle to the surveying instrument as an angle from the measured value of the inertial measurement unit and the measured value of the angle detector;
(c) a step of rotatably driving, by the light transmitter control unit, the drive unit such that the light transmission direction of the tracking guide light of the light transmitter main body is directed to the surveying instrument based on the angle and the measured value of the angle detector;
(d) a step of transmitting, by the light transmitter control unit, the tracking guide light from the light transmitter main body; and
(e) a step of receiving, by the light receiving unit, the tracking guide light to detect a direction of a center of the light transmitter, and searching for, by the surveying instrument, the prism in a vertical direction to lock the prism.

### Advantageous Effects

As is clear from the above description, the present disclosure relates to a light transmitter that automatically directs a light transmission port to a surveying instrument, a survey system, and a method for automatically resuming tracking.

### BRIEF DESCRIPTION OF DRAWINGS

FIG. 1 illustrates a schematic configuration of a survey system including a light transmitter according to a first embodiment.

FIG. 2 illustrates a front view of a surveying instrument.

FIG. 3 illustrates a schematic internal structure of the surveying instrument.

FIG. 4 illustrates a block diagram of the surveying instrument.

FIG. 5 illustrates a schematic configuration of a target unit as a side view.

FIG. 6 illustrates a block diagram of the light transmitter.

FIG. 7 illustrates processing Of the surveying instrument and the light transmitter at the start of tracking and during tracking as an explanatory diagram.

FIG. 8 illustrates processing of the light transmitter when tracking deviates as an explanatory diagram.

FIG. 9 illustrates a flow of resuming an auto-tracking.

FIG. 10 illustrates a schematic configuration of a survey system including a light transmitter according to a second embodiment.

FIG. 11 illustrates a block diagram of the light transmitter according to the second embodiment.

FIGS. 12A and 12B illustrate a polygon mirror and peripheral side surfaces of the polygon mirror as developed views.

FIG. 13 illustrates a plan view of a surveying instrument and a fan beam transmitting unit. FIG. 13 also illustrates an explanatory view for describing an effect.

### DESCRIPTION OF EMBODIMENTS

Hereinafter, preferred embodiments of the present disclosure will be described with reference to the drawings, but the present disclosure is not limited thereto. In each embodiment, the same constituents are denoted by the same reference signs, and redundant description will be omitted.

### First Embodiment

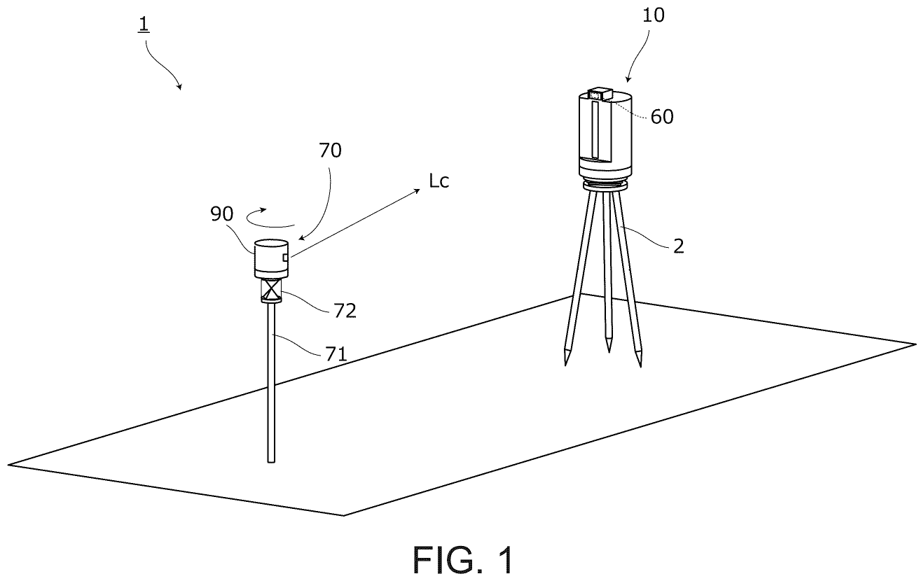

FIG. 1 illustrates a schematic configuration of a survey system 1 according to a first embodiment of the present disclosure.

The survey system 1 includes a surveying instrument 10 and a target unit 70.

The surveying instrument 10 is a total station having a distance measuring/angle measuring function and a tracking function. Furthermore, the surveying instrument 10 also includes a light receiving unit 60.

The target unit 70 has a prism 72, which is a target of the surveying instrument 10 and totally reflects light, at an upper end of a pole 71. An operator grips and transports the target unit 70. The operator installs the target unit 70 substantially vertically at a measurement point. The surveying instrument 10 measures the target unit 70.

The target unit 70 includes a light transmitter 90. While the surveying instrument 10 is tracking the prism 72, the light transmitter 90 transmits and receives various types of data to and from the surveying instrument 10 as needed. When the tracking deviates, the light transmitter 90 rotates to the surveying instrument 10 and transmits infrared tracking guide light Lc toward the surveying instrument 10.

The light receiving unit 60 of the surveying instrument 10 can receive the tracking guide light Lc, detect a direction of the prism 72, lock (collimate) the prism 72 again, and quickly resume tracking.

### Surveying Instrument

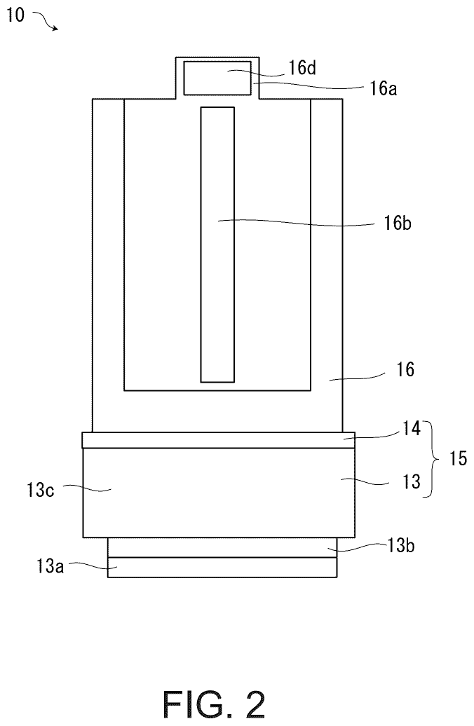

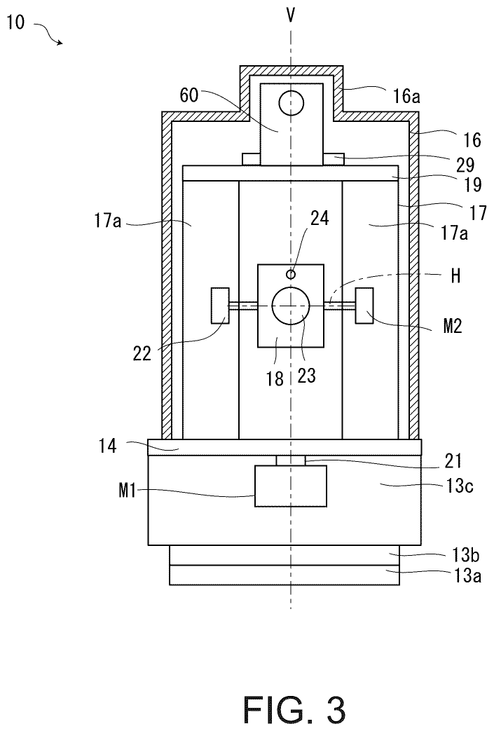

The surveying instrument 10 will be described with reference to FIGS. 2 to 4. FIG. 2 is a front view of the surveying instrument 10. FIG. 3 illustrates a schematic diagram of an internal structure of the surveying instrument 10.

As illustrated in FIGS. 2 and 3, the surveying instrument 10 comprises a surveying instrument main body 15 including a base portion 13 and a rotation seat 14 rotated in a horizontal direction with respect to the base portion 13, and a cover member 16.

The base portion 13 is roughly configured with a fixing seat 13a fixed to a tripod mount 2, a leveling stand 13b having leveling screws (not illustrated), and a case 13c incorporating a drive mechanism such as a horizontal rotation drive unit M1 that drives the rotation seat 14 to be rotated in the horizontal direction about a vertical axis V.

A bracket portion 17 including a pair of support members 17a is erected on the rotation seat 14. A lens barrel portion 18 of a distance measuring optical system and a tracking optical system is disposed between the support members 17a. The lens barrel portion 18 is rotatably supported in the vertical direction by a horizontal shaft H provided in the bracket portion 17. The lens barrel portion 18 houses a distance-measuring unit 23 and a tracking unit 24.

A vertical rotation drive unit M2 that rotatably drives the lens barrel portion 18 in the vertical direction is fixed to one end of the horizontal shaft H. A vertical angle detector 22 for detecting a rotation angle of the lens barrel portion 18 is provided at the other end thereof.

A horizontal plate 19, which is a thin plate disposed horizontally across the pair of support members 17a, is fixed to an upper end of the bracket portion 17. A surveying instrument control unit 29 and a light receiving unit 60 are attached to an upper surface of the horizontal plate 19.

The cover member 16 has a protruding portion 16a protruding to the upper surface. A front surface of the protruding portion is flush with the front surface of the cover member. The light receiving unit 60 is disposed at the center of horizontal plate 19 to be inside the protruding portion 16a.

The surveying instrument control unit 29 is mounted on a circuit board. The surveying instrument control unit 29 is disposed behind the light receiving unit 60 at the center of the horizontal plate 19.

Two windows are provided on the front surface of the cover member 16, that is, a light receiving unit window 16d and a lens barrel window 16b. The light receiving unit window 16d is provided on the front surface of the protruding portion 16a. The lens barrel window 16b is provided to extend in the vertical direction at the center of the front surface of the protruding portion 16a.

The lens barrel window 16b is formed on the optical axis of the lens barrel portion 18, and transmits therethrough infrared laser light of the optical systems of the distance-measuring unit 23 and the tracking unit 24. The light receiving unit window 16d is formed in front of the light receiving unit 60. The light receiving unit 60 receives the tracking guide light Lc through the light receiving unit window 16d.

The surveying instrument 10 connects to an operation terminal (not illustrated) having a display unit and an input unit The operation terminal is, for example, a smartphone or a tablet, and has a controller function of the surveying instrument 10 by an application being installed therein. An operator carries the operation terminal, and inputs a command as needed while checking a surveying status on the display.

### Block Diagram

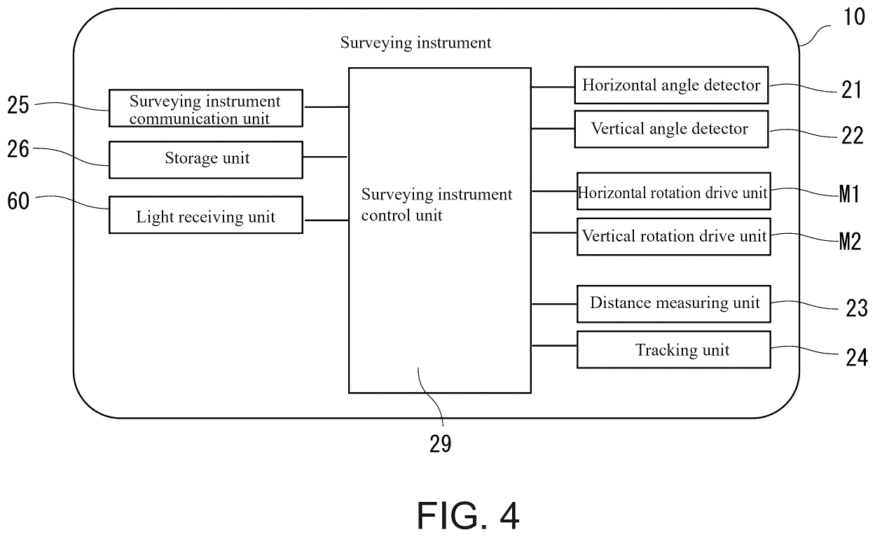

FIG. 4 illustrates a control block diagram of the surveying instrument 10. The surveying instrument 10 includes a horizontal angle detector 21, a vertical angle detector 22, a horizontal rotation drive unit M1, a vertical rotation drive unit M2, a distance-measuring unit 23, a tracking unit 24, a surveying instrument communication unit 25, a storage unit 26, and a surveying instrument control unit 29, which connects to and control all of these constituents.

The horizontal angle detector 21 and the vertical angle detector 22 are each implemented using absolute encoders or incremental encoders having a rotating disk, a slit, a light emitting diode, and an image sensor. The horizontal angle detector 21 is provided at a rotation shaft of the rotation seat 14 to detect a horizontal angle of the rotation seat 14. The vertical angle detector 22 is provided at the horizontal shaft H of the lens barrel portion 18 to detect a vertical angle of the lens barrel portion 18.

The horizontal rotation drive unit M1 and the vertical rotation drive unit M2 are each implemented using motors. Under the control of the surveying instrument control unit 29, the horizontal rotation drive unit M1 moves the rotation axis of the rotation seat 14, and the vertical rotation drive unit M2 moves the horizontal shaft H of the lens barrel portion 18. Both of the drive units cooperatively rotate the lens barrel portion 18. The horizontal angle detector 21 and the vertical angle detector 22 configure an angle-measuring unit. The horizontal rotation drive unit M1 and the vertical rotation drive unit M2 configure a drive unit.

The distance-measuring unit 23 includes a light transmitting unit and a light receiving unit. The distance-measuring unit 23 collimates the prism 72 that is omnidirectional retroreflector as a target. The distance-measuring unit 23 emits totally reflected light as distance-measuring light, such as infrared laser light, to the prism 72. The distance-measuring unit 23 receives reflected light with the light receiving unit to measure a distance to the center of the prism 72 based on the phases difference or time difference between the distance-measuring light and internal reference light.

The tracking unit 24 includes a tracking light transmitting system that emits, as tracking light, infrared laser light having a wavelength different from that of distance-measuring light, and a tracking light receiving system including an image sensor such as a CCD sensor or a CMOS sensor. The tracking unit 24 acquires a landscape image including tracking light and a landscape image excluding the tracking light, and sends both images to the surveying instrument control unit 29. The surveying instrument control unit 29 obtains the center of a target image from a difference between the two images, detects the center as a target position, and performs automatic tracking so that the lens barrel portion 18 always faces the target and a distance between the center of the target image and the visual axis center of the lens barrel portion 18 falls within a certain value.

The surveying instrument communication unit 25 is a communication interface that facilitates information exchanges and reception of information between the surveying instrument 10 and the measuring module. Examples of communication means include Bluetooth (a £ registered trademark). The communication means is not limited thereto, and may be implemented using other known methods for wired and wireless communication standards.

The storage unit 26 is implemented using computer-readable storage media, such as hard disc drives (HDDs). The storage unit 26 stores programs for the surveying instrument 10 to execute various functions such as a surveying function and an auto-tracking function. In addition, the storage unit 26 also stores various types of data, such as measurement data, acquired by the surveying instrument 10.

The light receiving unit 60 is implemented using a light receiving sensor, and receives the tracking guide light Lc. The light receiving unit 60 is disposed on the front of the surveying instrument 10 to detect a horizontal direction of the light transmitter 90 that transmits t the tracking guide light Lc.

The surveying instrument control unit 29 is a microcontroller in which, for example, a CPU, a ROM, and a RAM are mounted in an integrated circuit. The surveying instrument control unit 29 connects to all the devices of the surveying instrument 10 to control such constituents. The surveying instrument control unit 29 connects to all the devices of the surveying instrument 10 to control such constituents. For example, the surveying instrument control unit 29 controls the horizontal rotation drive unit M1 and the vertical rotation drive unit M2. The surveying instrument control unit 29 also controls light emission of the distance-measuring unit 23 and the tracking unit 24. The surveying instrument control unit 29 also performs an auto-tracking of the prism 72, automatic collimation, distance measurement and angle measurement, and control of the light receiving unit 60. The surveying instrument control unit 29 also transmits and receives measurement data and commands with the surveying instrument communication unit 25.

### Target Unit

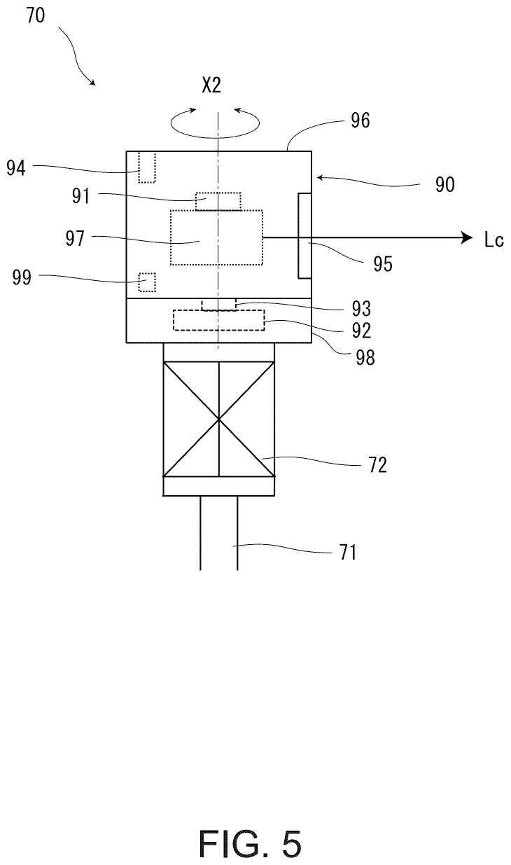

Next, the target unit 70 will be described with reference to the drawings. FIG. 5 is a side view of the target unit 70. See also the perspective view of the target unit 70 of FIG. 1. As illustrated in FIGS. 1 and 5, the target unit 70 has the prism 72 attached to the upper end of the pole 71. The optical center of the prism 72 passes through the central axis of the pole 71. A distance, which is so-called attachment height, between the optical center of the prism 72 and the lower end of the pole 71 is known.

Furthermore, the light transmitter 90 is provided on the upper portion of the prism 72.

The light transmitter 90 includes a light transmitter base portion 98 attached to the upper portion of the target unit 70 and a light transmitter main body 96 supported on the light transmitter base portion 98 to be rotatable in the horizontal direction with respect to a vertical axis X2. The light transmitter 90 is attached to the upper portion of the prism 72 with the vertical axis X2 coinciding with the central axis of the pole 71. A light transmission port 95 is provided on the peripheral side surface of the light transmitter main body 96. The light transmission port 95 transmits the tracking guide light Lc therethrough.

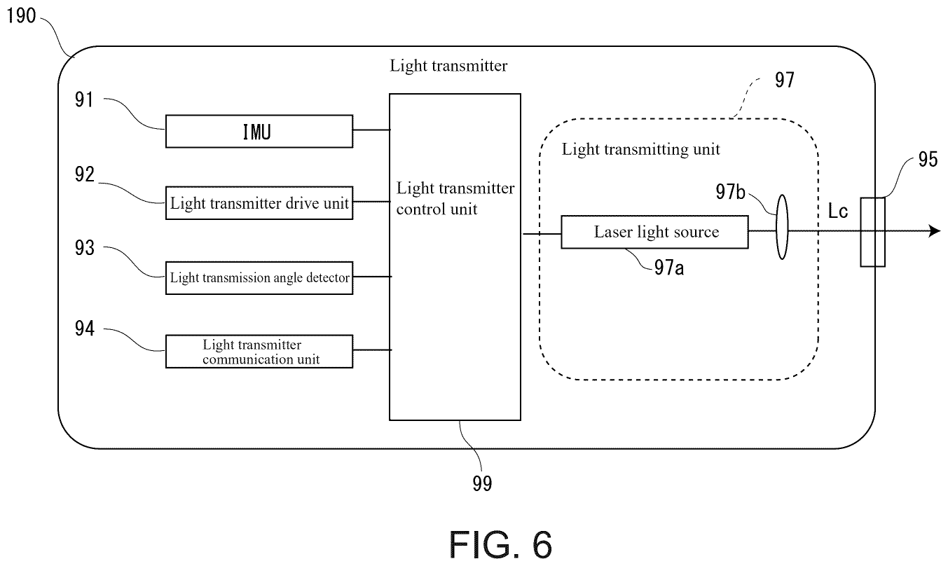

FIG. 6 illustrates a control system block diagram of the light transmitter 90. The light transmitter 90 comprises an inertial measurement unit (IMU) 91, a light transmitter drive unit 92, a light transmitter angle detector 93, a light transmitter communication unit 94, a laser light source 97a included in a light transmitting unit 97, and a light transmitter control unit 99 that controls these constituents.

The IMU 91 includes a three-axis gyroscope and an accelerometer in three directions, to measure angular velocities and accelerations in three axis directions. The IMU 91 is disposed such that the measurement center point passes through the central axis of the pole 71.

The light transmitter drive unit 92 is implemented using a motor, and horizontally rotatably drives the light transmitter main body 96 about the vertical axis X2.

The light transmitter angle detector 93 is implemented using an encoder to detect a rotation angle about the vertical axis X2.

In this embodiment, a light transmission direction of the tracking guide light Lc is set as a reference direction AX, and the light transmitter angle detector 93 detects a rotation angle with respect to the reference direction AX.

The light transmitter communication unit 94 has a configuration equivalent to that of the surveying instrument communication unit 25, and can transmit and receive information to and from the surveying instrument 10.

The light transmitting unit 97 is implemented by a laser light source 97a using a laser light emitting diode and a lens 97b. The light transmitting unit 97 transmits light emitted from the laser light source 97a in the orthogonal direction to the vertical axis X2, as the tracking guide light Lc from the light transmission port 95 by using the lens 97b. The reference direction AX is a direction in which the light transmitter 90 transmits the tracking guide light Lc from the vertical axis X2.

The light transmitter control unit 99 is a microcontroller in which, for example, a CPU, a ROM, and a RAM are mounted in an integrated circuit. The light transmitter control unit 99 connects to the devices of the light transmitter 90 to control such constituents. Examples of control include lighting control of the light transmitting unit 97, arithmetic processing for detected data of the light transmitter angle detector 93 and the IMU 91, control of the light transmitter drive unit 92, and transmission and reception of data with the surveying instrument 10 via the light transmitter communication unit 94. In addition, the light transmitter control unit 99 also includes a memory. The memory stores a program as well as received data and measurement data.

The light transmitter control unit 99 acquires a measured value of the IMU 91 as needed while the surveying instrument 10 is tracking the prism 72. The light transmitter control unit 99 receives a movement direction of the prism 72 and a horizontal direction angle of the surveying instrument 10. Based on these values, the light transmitter control unit 99 calculates a difference value between the current reference direction AX of the light transmitter 90 and an azimuth angle of the surveying instrument 10. The light transmitter control unit 99 allows the reference direction AX of the light transmitter 90 to be directed to the surveying instrument 10 (details thereof will be described later).

When the tracking of the prism 72 by the tracking unit 24 deviates, the light transmitter control unit 99 controls the light transmitter drive unit 92 to direct the reference direction AX to the direction of the surveying instrument 10 immediately before the tracking deviates, directs the reference direction AX of the light transmitter 90, that is, the light transmission direction to the surveying instrument 10, and turns on the laser light source 97a to transmit the tracking guide light Lc.

In this embodiment, the light transmitter main body 96 is only rotated in the horizontal direction. The light transmitter 90 may include a vertical rotation drive unit to rotate the light transmitter main body 96 in the vertical direction to rotate the tracking guide light Lc in the vertical direction. Since the tracking guide light Lc is infrared light, an operator does not visually recognize the tracking guide light Lc.

### Tracking Resumption Method

The light transmitter 90 has a function of, when tracking deviates, automatically rotating toward the surveying instrument 10 and transmitting the tracking guide light Lc to facilitate the surveying instrument 10 to resume the tracking. This will be described in detail with reference to the drawings.

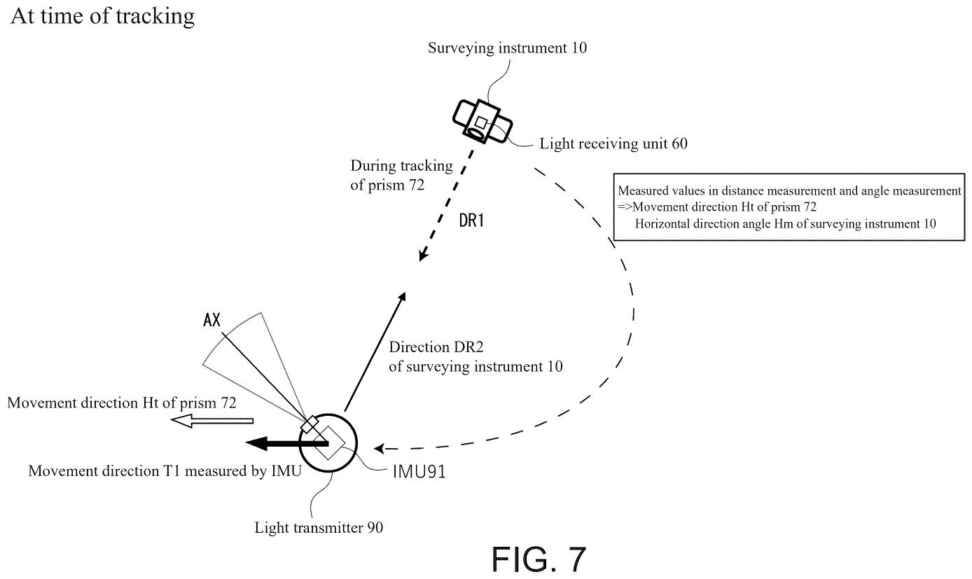

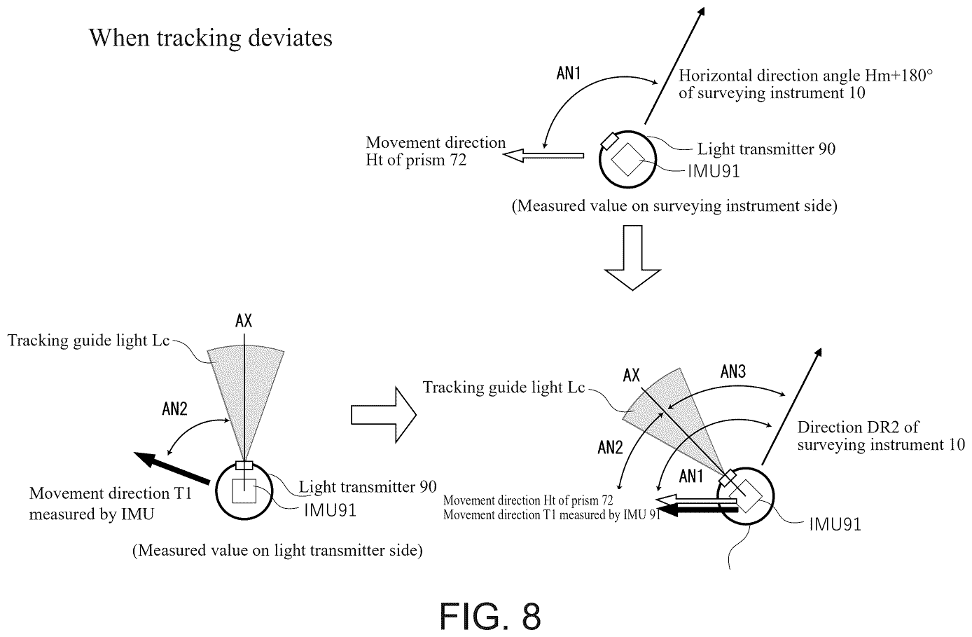

FIG. 7 illustrates processing of the surveying instrument 10 and the light transmitter 90 during tracking. FIG. 8 illustrates processing of the light transmitter 90 when the tracking deviates.

When the tracking unit 24 locks the prism 72 to start tracking, the surveying instrument 10 transmits a signal to the light transmitter 90. Upon receiving the signal, the light transmitter 90 also starts process.

Next, the surveying instrument 10 measures a distance to and an angle of the prism 72. During tracking, a distance to and an angle of the prism 72 are measured as needed. The surveying instrument control unit 29 calculates a horizontal direction angle Hm of the surveying instrument 10 to the prism 72 based on the measured distance/angle data, and a movement direction Ht (described later) of the prism 72 based on a difference value of the measured values to transmit the calculated results to the light transmitter 90.

Arithmetic processing for the measured distance/angle data is performed by the surveying instrument control unit 29, and an arithmetic result is transmitted to the light transmitter 90. However, the measured distance/angle data may be transmitted to the light transmitter 90, and arithmetic processing for the data may be performed by the light transmitter control unit 99.

When tracking starts, the IMU 91 measures acceleration and angular velocity. A measured value is stored with timestamps at the time of the measurement.

The movement direction of the light transmitter 90 (that is, the prism 72) is calculated on the basis of the acceleration. As illustrated in FIG. 7, at the time of tracking, the movement direction Ht (thick white arrow in FIG. 7) of the prism 72 acquired from the surveying instrument 10 coincides with a movement direction T1 (thick black arrow in FIG. 7) of the prism 72 calculated from the IMU 91. As a result, synchronization and correction of the acquired data can be achieved.

While tracking, since the surveying instrument 10 always directs the optical axis toward the prism 72, a direction (arrow DR1) of the prism 72 viewed from the surveying instrument 10 and a direction (arrow DR2) of the surveying instrument 10 viewed from the prism 72 are opposite directions.

The processing of the surveying instrument 10 and the light transmitter 90 when tracking deviates will be described with reference to FIG. 8.

When the tracking deviates, first, the surveying instrument 10 transmits a signal to receive the signal, and the light transmitter 90 also starts processing when tracking deviates.

Since the surveying instrument 10 does not lock the prism 72, the direction (arrow DR1) of the prism 72 viewed from the surveying instrument 10 and the direction (arrow DR2) of the surveying instrument 10 viewed from the prism 72 do not match even if the directions are opposite. Then, the light transmitter control unit 99 compares the acquired data of the surveying instrument 10 with the acquired data from the light transmitter 90 acquired immediately before the tracking deviates.

The light transmitter control unit 99 extracts the movement direction T1 of the prism 72 immediately before the tracking deviates. The light transmitter control unit 99 calculates an azimuth angle AN2, which is angle of the reference direction AX with respect to the movement direction T1 based on the measured value by the light transmitter angle detector 93.

In addition, the light transmitter control unit 99 extracts the movement direction Ht of the prism 72 and the horizontal direction angle Hm of the surveying instrument 10 to the prism 72 immediately before the tracking deviates received from the surveying instrument 10. The light transmitter control unit 99 calculates a horizontal direction angle Hm+180 degrees as an opposite direction to the horizontal direction angle Hm of the surveying instrument 10 to the prism 72. The light transmitter control unit 99 sets the angle as a direction angle of the light transmitter 90 to the surveying instrument 10. This is because, since the surveying instrument 10 always directs the optical axis toward the prism 72 during tracking, an opposite direction to the direction (arrow DR1) of the prism 72 viewed from the surveying instrument 10 is the direction (arrow DR2) of the surveying instrument 10 viewed from the prism 72. The light transmitter control unit 99 calculates an azimuth angle AN1, in which 180 degrees added to the horizontal direction angle Hm, with respect to the movement direction Ht of the prism 72.

The light transmitter control unit 99 calculates an angle AN3, which is a difference value between the azimuth angle AN1 and the azimuth angle AN2. The angle AN3 is an angle indicating a difference between the reference direction AX and the direction of the surveying instrument 10. The light transmitter control unit 99 controls the light transmitter drive unit 92 to horizontally rotate the light transmitter main body 96 by the angle AN3, to direct the reference direction AX toward the surveying instrument 10. The light transmitter control unit 99 turns on the laser light source 97a to transmit the tracking guide light Lc toward the surveying instrument 10.

The surveying instrument 10 receives the tracking guide light Lc with the light receiving unit 60 to detect the horizontal direction of the center of the tracking guide light Lc. The lens barrel portion 18 is driven in the vertical direction to lock the prism 72.

When resuming the tracking, the light transmitter 90 stops transmission of the tracking guide light Lc.

Even in a state without any clue, the prism can be locked through scanning with tracking light in all directions, but it takes time, which is a problem. The light transmitter 90 can transmit the tracking guide light Lc toward the surveying instrument 10 to instruct the direction of the prism 72 when tracking deviates. The operator does not need to direct the tracking guide light Lc toward the surveying instrument 10. When tracking deviates, the light transmitter 90 automatically rotates toward the surveying instrument 10 and transmits the tracking guide light Lc.

The surveying instrument 10 may receive measurement data of the IMU 91 from the light transmitter 90 as needed to ascertain a movement direction and a speed of the prism 72. When a moving speed of the prism 72 is high, the surveying instrument 10 shortens a measurement interval of the prism 72 to prevent deviation from occurring. Even when tracking deviates, the light transmitter control unit 99 uses more recent data. To shorten a time until tracking is resumed, the light transmitter control unit 99 calculates a direction in which the light transmitter 90 should turn when tracking deviates.

In a conventional surveying instrument, a light transmitting unit of a tracking unit emits tracking light, and a light receiving unit receives reflected light to perform scanning. In this case, since the light receiving unit receives reflected light, an amount of received light is small. In contrast, the surveying instrument 10 receives the tracking guide light Lc transmitted from the target side via the light receiving unit 60, and thus a large amount of received light is also easy to detect. Therefore, the prism 72 can be locked more quickly.

The light transmitter control unit 99 may drive the light transmitter drive unit 92 based on the angle AN3 calculated at all times so that the reference direction AX is always directed toward the surveying instrument 10.

### Tracking Continuation Flow

A description will be made of an auto-tracking continuation flow, in which tracking is automatically resumed even if the tracking deviates by using the above configuration.

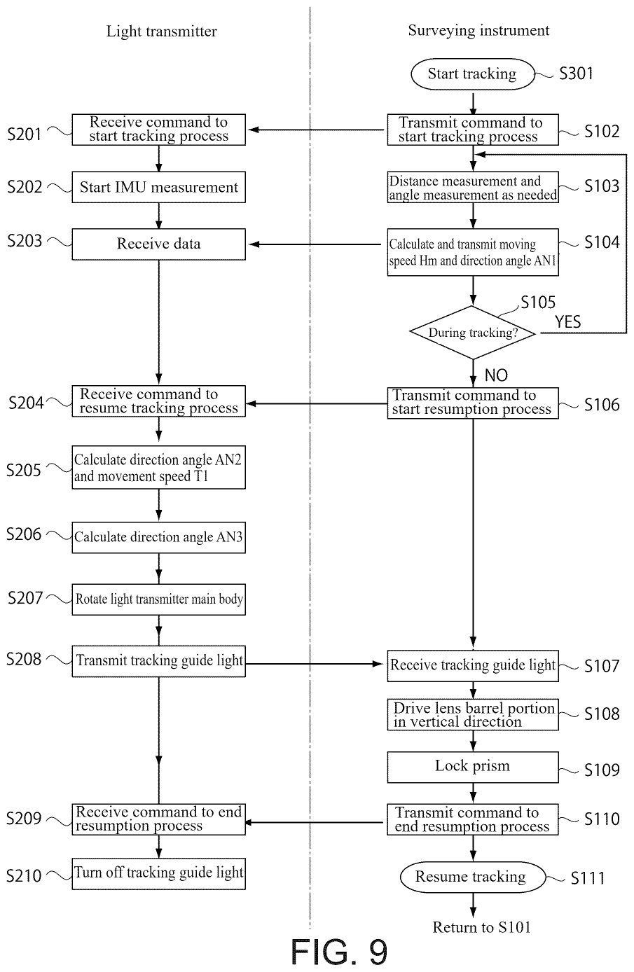

FIG. 9 illustrates a flow of an auto-tracking continuation. Since the surveying instrument 10 and the light transmitter 90 may perform processing simultaneously, the processing of the surveying instrument 10 will be described as steps S101 to S111, and the processing of the light transmitter 90 will be described as steps S201 to S211.

First, in step S101, the tracking unit 24 of the surveying instrument 10 locks the prism 72 and starts tracking.

Next, in step S102, the surveying instrument 10 sends a command to the light transmitter 90 to start a tracking process. The light transmitter 90 receives the command. This processing will be described later.

Next, in step S103, the surveying instrument 10 measures a distance to and an angle of the locked prism 72. The surveying instrument 10 measures a distance and an angle at predetermined time intervals.

Next, in step S104, the surveying instrument control unit 29 calculates the movement direction Ht of the prism 72 and the horizontal direction angle Hm of the surveying instrument 10 based on measured valued acquired through the distance measurement and angle measurement, and transmits the calculation results to the light transmitter 90.

Next, the processing proceeds to step S105, and if tracking is being continued, the processing returns to step S103. When the tracking deviates, the processing proceeds to step S106.

In step S106, a command is transmitted to the light transmitter 90.

Next, in step S107, the light receiving unit 60 receives the tracking guide light Lc transmitted by the light transmitter 90. As a result, the horizontal direction of the light transmitter 90 is detected.

Next, the processing proceeds to step S108, and the surveying instrument 10 drives the lens barrel portion 18 in the vertical direction while the tracking unit 24 emits tracking light to search for the prism 72 in the vertical direction.

Next, the processing proceeds to step S109, and the tracking unit 24 locks the prism 72.

Next, the processing proceeds to step S110, and the prism is locked and the tracking is resumed. The surveying instrument 10 transmits a command to the light transmitter 90 to end the tracking resumption process.

Next, the processing proceeds to step S111, and tracking is resumed. The processing returns to step S101.

Next, a processing flow of the light transmitter 90 will be described.

First, in step S201, the light transmitter 90 receives a command to start a tracking process from the surveying instrument 10 (see step S102). Upon receiving the command, the light transmitter 90 starts a tracking process.

Next, the processing proceeds to step S202, and the IMU 91 starts measurement. The IMU 91 measures three-axis accelerations and tree-axis angular velocities at predetermined time intervals.

Next, the processing proceeds to step S203, and the light transmitter 90 receives the movement direction Ht of the prism 72 and the horizontal direction angle Hm of the surveying instrument 10 from the surveying instrument 10 (see step S 104). Steps S202 and S203 are continuously performed until step S204.

Next, in step S204, the light transmitter 90 receives a command for processing of resuming tracking from the surveying instrument 10 (see step S 106). As a result, the light transmitter 90 performs process for resuming tracking (steps S205 to S209).

The processing proceeds to step S205, the light transmitter control unit 99 calculates the azimuth angle AN2 and the movement direction T1 on the basis of the measurement data of the IMU 91 and the measurement data of the light transmitter angle detector 93.

Next, the processing proceeds to step S206, and the light transmitter control unit 99 calculates the angle AN3 by matching the calculation result in step S205 with the movement direction Ht of the prism 72 and the horizontal direction angle Hm of the surveying instrument 10 received in step S203.

Next, the processing proceeds to step S207, and the light transmitter control unit 99 rotates the light transmitter main body 96 by the angle AN3 calculated in step S206 to direct the reference direction AX toward the surveying instrument 10.

Next, the processing proceeds to step S208, and the light transmitter 90 transmits the tracking guide light Lc. The light receiving unit 60 of the surveying instrument 10 receives the tracking guide light Lc (see step S107).

The processing proceeds to step S209, and the light transmitter 90 receives a command to end the tracking resumption process from the surveying instrument 10 (see step S110).

Next, the processing proceeds to step S210, and the light transmitter 90 turns off the tracking guide light Lc to stop the light transmission.

According to the flow of the above processing, even when the tracking deviates, the processing for resuming the tracking is automatically performed, and the tracking is resumed although an operator does not do anything.

### Second Embodiment

Next, a second embodiment will be described. Constituents similar to those of the first embodiment are denoted by the same reference signs, and detailed description thereof will be omitted.

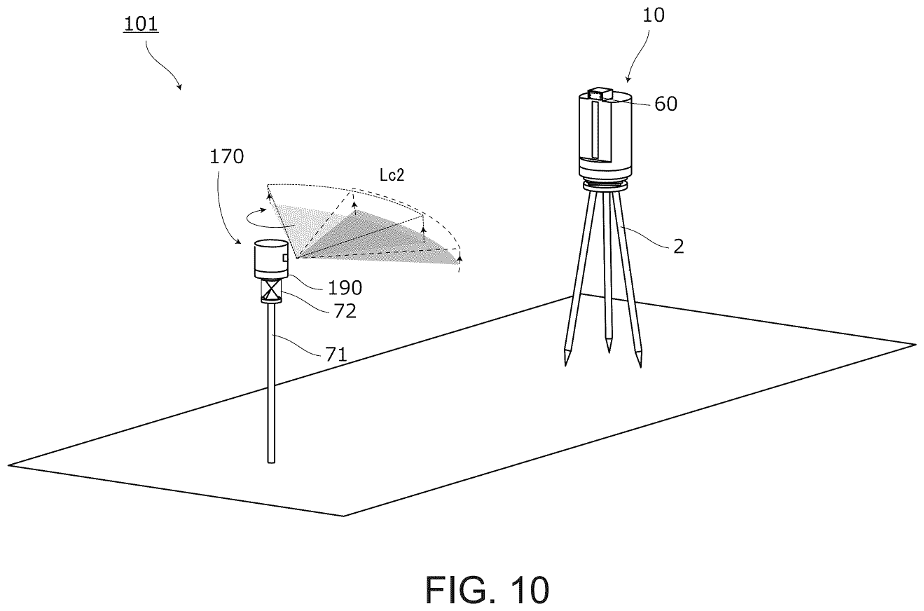

FIG. 10 illustrates a schematic configuration of a survey system 101 including a target unit 170 according to the second embodiment.

The survey system 101 includes a surveying instrument 10 and the target unit 170.

The target unit 170 includes the prism 72 provided at the upper end of the pole 71 and a light transmitter 190. The light transmitter 190 has the same configuration as the light transmitter 90 of the first embodiment except that a fan beam light transmitting unit 200 is provided instead of the light transmitting unit 97. The fan beam light transmitting unit 200 transmits a fan beam that is narrow in the vertical direction and spreads in the horizontal direction as tracking guide light Lc2. The fan beams are transmitted in a pair in the horizontal direction. The pair of fan beams are transmitted such that the fan beams partially overlap each other in different directions in the horizontal direction. Fan beams are moved in the vertical direction.

The surveying instrument 10 has similar configuration to that of the surveying instrument 10 except that the light receiving unit 60 receives the tracking guide light Lc2 that is a fan beam. In the present embodiment, the surveying instrument control unit 29 counts the number of times the light receiving unit 60 receives the fan beam within a predetermined time. The pair of fan beams, which is the tracking guide light Lc2, is moved in the vertical direction and the light transmitter 190 detects a direction of the surveying instrument 10 on the basis of the number of times the light receiving unit 60 receives the fan beams to direct the reference direction AX toward the surveying instrument 10 (which will be described later).

### Fan Beam Light Transmitting Unit

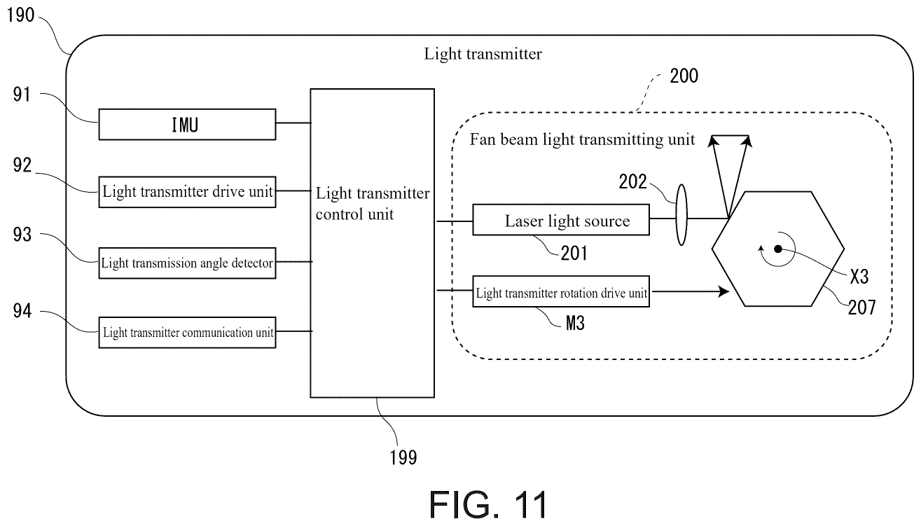

FIG. 11 is a block diagram of the light transmitter 190 including the fan beam light transmitting unit 200.

The fan beam light transmitting unit 200 includes a laser light source 201 that emits laser light, a cylindrical lens 202 that horizontally expands light emitted from the laser light source 201, a polygon mirror 207 of which a peripheral surface is formed of a reflection surface, and a motor M3 that rotatably drives the polygon mirror 207.

Light incident on the cylindrical lens 202 is formed into a fan-shaped beam spread in the horizontal direction, is reflected by the peripheral surface of the polygon mirror 207 rotatably driven by the motor M3 about a central axis X3, and is applied in the vertical direction as a fan beam that is long in the horizontal direction and short in the vertical direction.

The light transmitter control unit 199 of the light transmitter 190 has a configuration similar to that of the light transmitter control unit 99 except that the fan beam light transmitting unit 200 is controlled instead of the light transmitting unit 97. The light transmitter control unit 199 also controls rotatable driving of the motor M and turning-on of the laser light source 201.

### Form of Polygon Mirror

The polygon mirror 207 and fan beams emitted by the polygon mirror 207 will be described in detail with reference to the drawings.

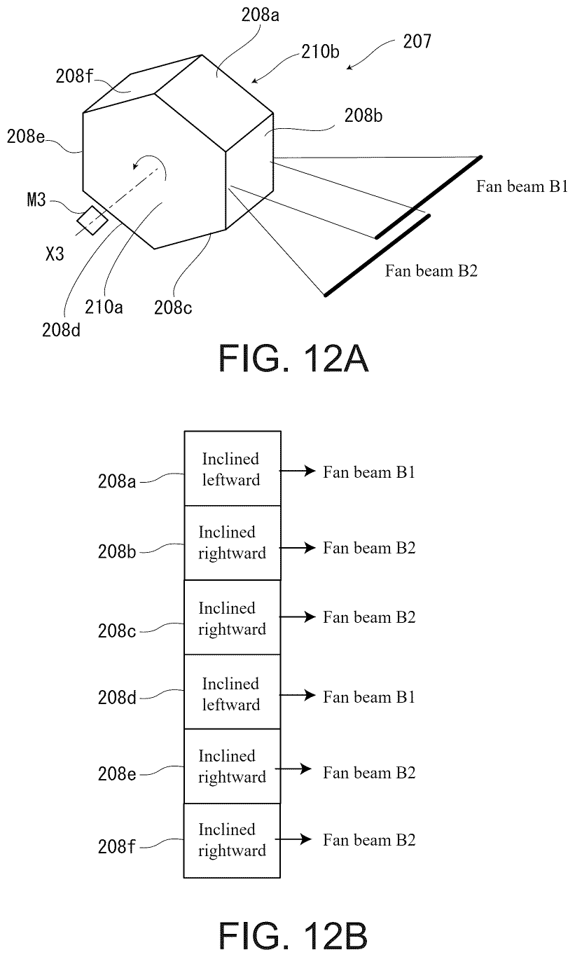

FIGS. 12A and 12B are explanatory diagrams of the polygon mirror 207. FIG. 12A is a perspective view of the polygon mirror 207. FIG. 12B is a developed view of peripheral side surfaces of the polygon mirror 207.

The polygon mirror 207 has an outer shape of a substantially regular hexagonal column, and six reflection surfaces such as a first reflection surface 208a, a second reflection surface 208b, a third reflection surface 208c, a fourth reflection surface 208d, a fifth reflection surface 208e, and a sixth reflection surface 208f are formed at equal intervals as peripheral side surfaces. Further, the polygon mirror 207 has a left end surface 210a to which one side of all the reflection surfaces is connected and a right end surface 210b to which the other side of all the reflection surfaces is connected.

The polygon mirror 207 is rotatably driven about the central axis X3 by the motor M3, and applies the light incident on the reflection surfaces 208a to 208f in the rotation direction. According to the present embodiment, light incident on a reflection surface reflects on the reflection surface, spreads in the horizontal direction, and is irradiated as a fan beam while moving in the vertical direction.

The first reflection surface 208a and the fourth reflection surface 208d slightly incline toward the left end surface 210a to reflect the incident fan beam slightly toward the left end surface 210a. The fan beam reflected relatively leftward by these two reflection surfaces of six reflection surfaces of the polygon mirror 207 is defined as a first fan beam B1.

On the other hand, the second reflection surface 208b, the third reflection surface 208c, the fifth reflection surface 208e, and the sixth reflection surface 208f slightly incline toward the right end surface 210b to reflect the incident fan beam slightly toward the right end surface 210b. The fan beam reflected relatively leftward by these four reflection surfaces of six reflection surfaces of the polygon mirror 207 is defined as a second fan beam B2.

The polygon mirror 207 reflects the incident light to either the left or the right. A method for reflecting a fan beam relatively separately in the left or right direction is not limited thereto. Other known methods may be used, such as performing surface processing on the reflection surfaces 208a to 208f to adjust reflection directions.

### Form of Fan Beam

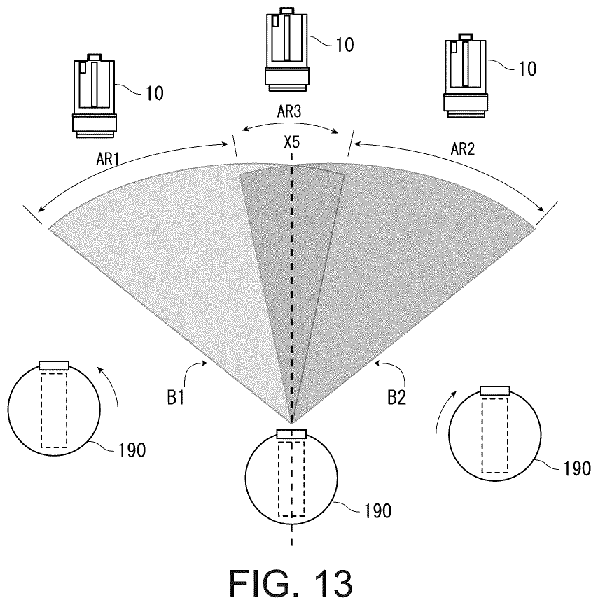

An effect of the light transmitter 190 having the above configuration will be described with reference to FIG. 13. FIG. 13 is a plan view illustrating the light transmitter 190 and the fan beam, and is an explanatory view mainly illustrating a form of a fan beam from the light transmitter 190.

As illustrated in FIG. 12, the first fan beam B1 and the second fan beam B2 reflected by the polygon mirror 207 are emitted to partially overlap each other while having different main irradiation directions in the horizontal direction.

As described above, when the tracking deviates, the light transmitter 90 rotates to direct the reference direction AX to the surveying instrument 10. Similarly, the light transmitter 190 rotates to direct the reference direction AX5 to the surveying instrument 10. The light transmitter 190 sets such that the reference direction AX5 of the light transmitter 190 passes through the center of an overlapping region of the first fan beam B1 and the second fan beam B2. The overlapping region is narrower than the horizontal spread of the first fan beam B1 and the second fan beam B2.

The first fan beam B1 is reflected from two surfaces of the six reflection surfaces of the polygon mirror 207. The second fan beam B2 is reflected from four surfaces of the six reflection surfaces of the polygon mirror 207. Thus, since the number of times the first fan beam B1 and the second fan beam B2 are received by the light receiving unit 60 is different for each time (cycle) during which the polygon mirror 207 makes one rotation, it is possible to distinguish between the first fan beam B1 and the second fan beam B2. Using this fact enables a direction of the surveying instrument 10 with respect to the reference direction AX5 of the light transmitter 190 to be detected.

A region scanned with only the first fan beam B1 will be referred to as a first region AR1. A region scanned with only the second fan beam B2 will be referred to as a second region AR2. A region to which the first fan beam B1 and the second fan beam B2 are transmitted will be referred to as a third region AR3.

Similarly to the light transmitter 90, when tracked, the light transmitter 190 starts measurement in the IMU 91 and receives measurement data from the surveying instrument 10 as needed. When the tracking deviates, the light transmitter control unit 99 is rotatably driven to direct the reference direction AX5 to the surveying instrument 10. The first fan beam B1 and the second fan beam B2 spreading in the horizontal direction are applied in the vertical direction toward the surveying instrument 10 as the tracking guide light Lc2.

The light transmitter 190 rotates the reference direction AX5 toward the surveying instrument 10 and transmits the tracking guide light Lc2. The tracking guide light Lc, which includes the pair of fan beams greatly expanding in the horizontal direction, is received by the light receiving unit 60 of the surveying instrument 10. The light transmitter 190 distributes reflection in the left-right direction, and the surveying instrument 10 can more easily receive the tracking guide light Lc.

When the surveying instrument 10 is disposed in the first region AR1, the light receiving unit 60 receives only the first fan beam B1. In response to the detection result, the light transmitter 190 rotates leftward in the horizontal direction such that the light transmitter 190 directs the reference direction AX5 to the surveying instrument 10. As a result, when the light receiving unit 60 receives the first fan beam B1 and the second fan beam B2, to determine that the surveying instrument 10 has entered the third region AR3.

Similarly, when the surveying instrument 10 is disposed in the second region AR2, the light receiving unit 60 receives only the second fan beam B2. In response to this detection result, the light transmitter 190 rotates rightward in the horizontal direction. As a result, when the light receiving unit 60 receives the first fan beam B1 and the second fan beam B2, to determine that the surveying instrument 10 has entered the third region AR3.

When the surveying instrument 10 receives light with the light receiving unit 60, the light transmitter control unit 99 directs the center of the third region AR3, that is, the reference direction AX5 toward the surveying instrument 10.

The light transmitter 190 detects a direction of the surveying instrument 10 based on the number of times the surveying instrument 10 receives light.

Since the surveying instrument 10 was tracking the prism 72 until immediately before the tracking deviates, the surveying instrument 10 has directed its collimation direction toward the light transmitter 190. So, the light transmitter 190 directing the reference direction AX5 in the direction immediately before the tracking deviates allows the light transmitter 190 to direct the reference direction AX5 to the state where the light transmitter 90 and the surveying instrument 10 were facing each other. After the tracking deviates, the surveying instrument 10 receives the tracking guide light Lc. When the surveying instrument 10 receives the first fan beam, the surveying instrument 10 is disposed on the left side of the first region AR1. The surveying instrument 10 is also relatively on the left side of the light transmitter 190 in the horizontal direction. The surveying instrument 10 rotates the lens barrel portion 18 slightly to the left in the horizontal direction while transmitting the tracking light and rotating the lens barrel portion 18 in the vertical direction to lock the prism 72.

When the surveying instrument 10 receives the second beam, the surveying instrument 10 is in the second region AR2 on the right side of the light transmitter 190. The surveying instrument 10 is relatively on the right side of the light transmitter 190 in the horizontal direction. The surveying instrument 10 rotates the lens barrel portion 18 slightly to the left in the horizontal direction while transmitting the tracking light and rotating the lens barrel portion 18 in the vertical direction to lock the prism 72.

Since the surveying instrument 10 has performed tracking until immediately before the tracking deviates, the prism 72 is present in the vicinity of the current collimation direction after the tracking deviates. When searching the prism 72, the surveying instrument 10 easily finds the prism 72 by ascertaining a search direction in a simplified manner. That is, ascertaining the left side or the right side from a position where the tracking deviates enables the surveying instrument 10 to easily find the prism 72. With this configuration, the surveying instrument 10 can detect a search direction, and shorten the time until the surveying instrument 10 resumes tracking.

Although the preferred embodiments of the present disclosure have been described above, the above-described embodiments are examples of the present disclosure, and these embodiments can be combined on the basis of knowledge of those skilled in the art, and such forms are also included in the scope of the present disclosure.

### REFERENCE SIGNS LIST

1: Survey system
10: Surveying instrument
21: Horizontal angle detector
22: Vertical angle detector
23: Distance-measuring unit
24: Tracking unit
60: Light receiving unit
72: Prism
90: Light transmitter
91: IMU (inertial measurement unit)
92: Light transmitter drive unit (drive unit)
93: Light transmitter angle detector (angle detector)
94: Light transmitter communication unit
96: Light transmitter main body
99: Light transmitter control unit
AN1: Azimuth angle
AN2: Azimuth angle
AN3: Angle
Ht: Movement direction (first movement direction)
Lc: Tracking guide light
T1: Movement direction (second movement direction)

1. A light transmitter comprising:
a transmitter main body configured to transmit tracking guide light;
a drive unit configured to drive the transmitter main body to be rotated horizontally;
an inertial measurement unit configured to measure accelerations in three axial directions of the transmitter main body;
an angle detector configured to detect a rotation angle of the transmitter main body;
a transmitter communication unit configured to transmit and receive information; and
a transmitter control unit configured to control arithmetic processing for measured values of the inertial measurement unit and the angle detector, the transmitter communication unit, transmission of the tracking guide light of the transmitter main body, and rotation of the drive unit, wherein
the light transmitter control unit causes the light transmitter communication unit to receive a horizontal direction angle from a surveying instrument to the light transmitter main body and a first movement direction of the light transmitter main body, calculates a difference between a light transmission direction of the tracking guide light and an azimuth angle to the surveying instrument as an angle from the measured value of the inertial measurement unit and the measured value of the angle detector, and rotatably drives the drive unit such that the light transmission direction of the tracking guide light is directed to the surveying instrument to transmit the tracking guide light.

2. The light transmitter according to claim 1, wherein
the light transmitter control unit calculates a second movement direction of the light transmitter from the measured value of the inertial measurement unit, matches the first movement direction and the second movement direction, and calculates a difference with a horizontal azimuth angle to the surveying instrument as an angle.

3. The light transmitter according to claim 1, wherein
the tracking guide light is emitted at different frequencies in a left region and a right region in a horizontal direction around the light transmission direction, and is emitted at a frequency different from both the frequency in the left region and the frequency in the right region in a region including the light transmission direction.

4. A survey system comprising:
a light transmitter including a light transmitter main body configured to transmit tracking guide light, a drive unit configured to drive the light transmitter main body to be rotated horizontally, an inertial measurement unit configured to measure accelerations in three axial directions of the light transmitter main body, an angle detector configured to detect a rotation angle of the light transmitter main body, a light transmitter communication unit configured to transmit and receive information, and a light transmitter control unit configured to control arithmetic processing for measured values of the inertial measurement unit and the angle detector, the light transmitter communication unit, light transmission of the tracking guide light of the light transmitter main body, and rotation of the drive unit;
a prism attached to the light transmitter; and
a surveying instrument including a light receiving unit configured to receive the tracking guide light, and a surveying instrument communication unit configured to communicate with the light transmitter communication unit, the surveying instrument having a distance measurement and angle measurement function of measuring a distance to and an angle of the prism and a tracking function of tracking the prism,
wherein
the light transmitter control unit causes the light transmitter communication unit to receive a horizontal direction angle from the surveying instrument to the light transmitter main body and a first movement direction of the light transmitter main body, calculates a difference between a light transmission direction of the tracking guide light and an azimuth angle to the surveying instrument as an angle from the measured value of the inertial measurement unit and the measured value of the angle detector, and rotatably drives the drive unit such that the light transmission direction of the tracking guide light is directed to the surveying instrument to transmit the tracking guide light.

5. A method for automatically resuming tracking when tracking deviates in a survey system that includes a light transmitter including a light transmitter main body configured to transmit tracking guide light, a drive unit configured to drive the light transmitter main body to be rotated horizontally, an inertial measurement unit configured to measure accelerations in three axial directions of the light transmitter main body, an angle detector configured to detect a rotation angle of the light transmitter main body, a light transmitter communication unit configured to transmit and receive information, and a light transmitter control unit configured to control arithmetic processing for measured values of the inertial measurement unit and the angle detector, the light transmitter communication unit, light transmission of the tracking guide light of the light transmitter main body, and rotation of the drive unit,
a prism attached to the light transmitter, and
a surveying instrument including a light receiving unit configured to receive the tracking guide light, and a surveying instrument communication unit configured to communicate with the light transmitter communication unit, the surveying instrument having a distance measurement and angle measurement function of measuring a distance to and an angle of the prism and a tracking function of tracking the prism, the method comprising:
(a) a step of receiving, by the light transmitter communication unit, a horizontal direction angle from the surveying instrument to the light transmitter main body and a first movement direction of the light transmitter main body from the surveying instrument;
(b) a step of calculating, by the light transmitter control unit, a difference between a light transmission direction of the tracking guide light and an azimuth angle to the surveying instrument as an angle from the measured value of the inertial measurement unit and the measured value of the angle detector;
(c) a step of rotatably driving, by the light transmitter control unit, the drive unit by the angle such that the light transmission direction of the tracking guide light of the light transmitter main body is directed to the surveying instrument;
(d) a step of transmitting, by the light transmitter control unit, the tracking guide light from the light transmitter main body; and
(e) a step of receiving, by the light receiving unit, the tracking guide light to detect a direction of a center of the light transmitter, and searching for, by the surveying instrument, the prism in a vertical direction to lock the prism.

6. The light transmitter according to claim 2, wherein
the tracking guide light is emitted at different frequencies in a left region and a right region in a horizontal direction around the light transmission direction, and is emitted at a frequency different from both the frequency in the left region and the frequency in the right region in a region including the light transmission direction.
